(19) United States
(12) Patent Application Publication
(10) Pub. No.: US 2017/0061449 A1
(43) Pub. Date: Mar. 2, 2017

(54) METHOD AND SYSTEM FOR IMPROVING PERFORMANCE OF A PRODUCT

(71) Applicant: Wipro Limited, Bangalore (IN)

(72) Inventors: Pankaj Suresh Bande, Nagpur (IN); Bittu Aby Raju, Mundakayam (IN); Midhun Mohan, Bangalore (IN)

(21) Appl. No.: 14/929,162

(22) Filed: Oct. 30, 2015

(30) Foreign Application Priority Data
Aug. 24, 2015 (IN) 4437/CHE/2015

(51) Int. Cl. G06Q 30/02

(52) U.S. Cl. CPC G06Q 30/0201

(57) ABSTRACT

The present disclosure relates to a method for improving performance of products based on behaviour of users while interacting with the products. In an embodiment one or more sensors are configured near the products. The sensors are configured to capture behaviour of users while interacting with the product. The behaviour of the users is characterized into behaviour parameters like expression of users, voice level of users, occupancy level of users and interaction of the users. The sensors transmit data associated with the behaviour parameters corresponding to each product to a behaviour analysis system. The behaviour analysis system determines behaviour values corresponding to the behaviour parameters and identifies the highest and lowest behaviour values. Based on the highest and the lowest behaviour values, the behaviour analysis system provides one or more recommendations to the products to improve the performance of the products.

This application claims the benefit of Indian Patent Application Serial No. 4437/CHE/2015, filed Aug. 24, 2015, which is hereby incorporated by reference in its entirety.

### FIELD

The present subject matter is related, in general to product analysis, and more particularly, but not exclusively to a method and system for improving performance of a product based on behaviour of users with the product.

### BACKGROUND

Generally, products such as Automated Teller Machine (ATM) machines, vending machines, gaming machines are placed in public places for public use. Further, many retail stores keep display of electronic products such as laptops, computers, refrigerators etc. Once these products are configured in specific public places, the users can interact with these products for either performing specific functions such as withdrawing money from ATM or buying specific retail products from a vending machine, or seeing the products for the purpose of buying or evaluating for buying.

It is of utmost interest to the product manufacturers or retailers to get clear, comprehensive and real-time view/response on how the users behave with the products once they are deployed or placed in a variety of public places. At present, finding out the user behavior with the product is not available as an inbuilt feature. The internal architecture of the product has to be changed for analyzing the behaviour of the user. Further, the information cannot be communicated to remote location in real time for further analysis and quick action/reaction/decisions for improving the performance of the product.

There already exists a wide range of products being deployed in the market. But these products are not able to provide the user analysis and status of the product. Therefore, upgrading and modification of the product design lacks the required inputs for building the newer version of the products.

Further, there is no add-on setup which can provide the user behavior and occupancy around a product without requirement for a change in the architecture of the product.

The issues mainly faced in product analysis for improving performance of product are to analyze user behaviour with the product for improving performance of the product without making changes to the internal architecture or design of the product being deployed.

### SUMMARY

Disclosed herein is a method and system for improving performance of a product. Real time performance evaluation of the product is done using one or more sensors that are deployed near the product. The one or more sensors capture behaviour of users while interacting with the product. Based on the behaviour of the product, behaviour analysis system provides one or more recommendations to improve performance of the product.

Accordingly, the present disclosure relates to a method for improving performance of one or more products. The method comprises receiving, by a behaviour analysis system, data associated with one or more behaviour parameters from one or more sensors in real-time, wherein the one or more behaviour parameters are associated with behaviour of one or more users while interacting with the one or more products. Upon receiving the data, the method proceeds to determine one or more behaviour values corresponding to the one or more behaviour parameters at predefined time intervals based on the received data. The method further comprises comparing the one or more behaviour values obtained at each predefined time interval for identifying a highest behaviour value and a lowest behaviour value corresponding to each of the one or more behaviour parameters. The behaviour analysis system provides one or more recommendations for improving the performance of each of the one or more products based on the highest and lowest behaviour value corresponding to each of the one or more behaviour parameters.

Further, the present disclosure relates to a behaviour analysis system for improving performance of one or more products wherein the behaviour analysis system comprises a processor and a memory communicatively coupled to the processor, wherein the memory stores processor-executable instructions, which, on execution, causes the processor to receive data. The data is associated with one or more behaviour parameters from one or more sensors in real-time, wherein the one or more behaviour parameters are associated with behaviour of one or more users while interacting with each of the one or more products. The processor determines one or more behaviour values corresponding to the one or more behaviour parameters at predefined time intervals based on the received data and compares the one or more behaviour values obtained at each predefined time interval. Further, the processor identifies a highest behaviour value and a lowest behaviour value corresponding to each of the one or more behaviour parameters based on the comparison. The processor provides one or more recommendations for improving the performance of each of the one or more products based on the highest and lowest behaviour value corresponding to each of the one or more behaviour parameters.

Furthermore, the present disclosure relates to a non-transitory computer readable medium including instructions stored thereon that when processed by at least one processor cause a behaviour analysis system to perform the acts of receiving data associated with one or more behaviour parameters from one or more sensors in real-time, wherein the one or more behaviour parameters are associated with behaviour of one or more users while interacting with each of the one or more products. The instructions further causes the behaviour analysis system to determine one or more behaviour values corresponding to the one or more behaviour parameters at predefined time intervals based on the received data. Thereafter, the behaviour analysis system compares the one or more behaviour values obtained at each predefined time interval for identifying a highest behaviour value and a lowest behaviour value corresponding to each of the one or more behaviour parameters. The behaviour analysis system provides one or more recommendations for improving the performance of each of the one or more products based on the highest and lowest behaviour value corresponding to each of the one or more behaviour parameters.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1a shows an exemplary environment illustrating a method for improving performance of one or more products in accordance with some embodiments of the present disclosure;

FIG. 1b shows a block diagram illustrating a behaviour analysis system in accordance with some embodiments of the present disclosure;

FIG. 1c shows a detailed block diagram illustrating a behaviour analysis system in accordance with some embodiments of the present disclosure;

FIG. 2 illustrates a method for improving performance of one or more products in accordance with some exemplary embodiments of the present disclosure;

FIG. 3 illustrates a flowchart showing method for improving performance of one or more products in accordance with some embodiments of the present disclosure; and

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure relates to a method and system for improving performance of one or more products based on behaviour of user. One or more sensors are configured at each of the one or more products. The one or more sensors are configured to monitor behaviour of one or more users while interacting with each of the one or more products. The one or more sensors transmit data associated with behaviour parameters of the one or more users to a behaviour analysis system in real-time. The behaviour analysis system determines behaviour values corresponding to behaviour parameters at each predefined time interval. The behaviour analysis system compares the behaviour values obtained at each predefined time interval to identify the highest behaviour value and lowest behaviour value corresponding to each behaviour parameter. The behaviour analysis system provides one or more recommendations for improving the performance of the product based on the highest and the lowest behaviour value.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

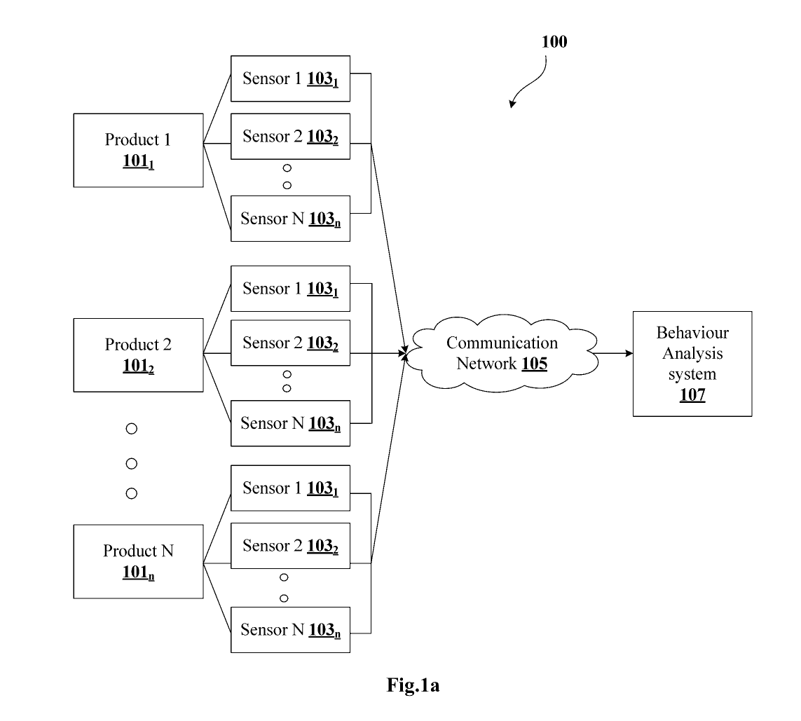

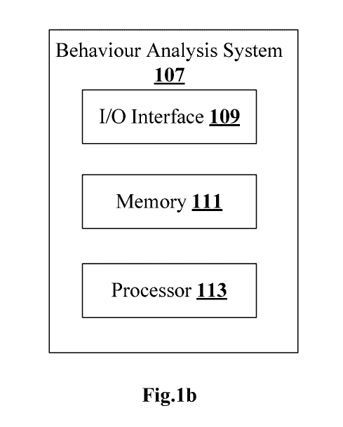

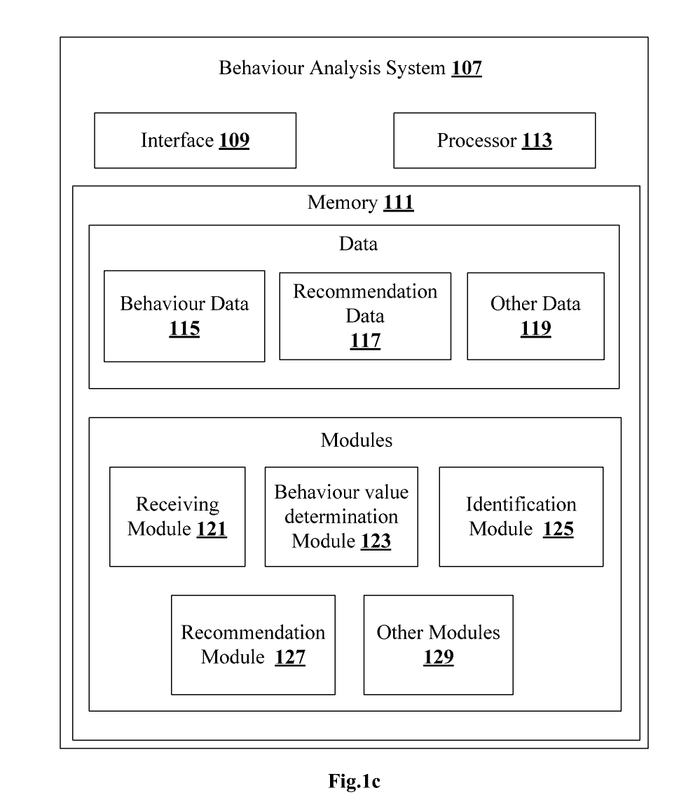

FIG. 1a shows an exemplary environment 100 illustrating a method for improving performance of one or more products in accordance with some embodiments of the present disclosure.

The environment 100 comprises of one or more products, product 1 1011 to product n 101n (collectively referred as products 101), one or more sensors sensor 1 1031 to sensor n 103n (collectively referred as sensors 103), a communication network 105 and a behaviour analysis system 107. As an example, the one or more products 101, may include, but not limited to, an ATM machine, a vending machine, a gaming machine and a display device. The one or more sensors 103, may include, but not limited to, a camera, a microphone, occupancy detection sensors like sharp GP2 sensors and Galvanic Skin Response (GSR) sensors. The communication network 105 may include but not limited to a wired communication network, a wireless communication network and a combination thereof. In an embodiment, the one or more sensors 103 are configured in the vicinity of each of the one or more products. The camera is used to capture expressions of one or more users while interacting with the product. The microphone is used to capture sound level/voice level of one or more users while interacting with each product. The sound level/voice level provides information of how excited the user is while interacting with the product. The occupancy detection sensor is configured to detect occupancy level of the users at each product. The occupancy level provides information of whether the product is gathering a good response from the users or not. If there is more number of users near the product then the occupancy level is more and if there is less number of users near the product then the occupancy level is less. The GSR sensor is configured to monitor response of each user for the product. In an embodiment, the expressions of the users, the sound level of the users, the occupancy level of the users and interaction of the users refers to behaviour parameters associated with behaviour of each user while interacting with the product or while evaluating the product. As an example, if the product is a gaming machine then an event may be configured for example a game in the gaming machine. In this scenario, the behaviour of users is monitored for the event in the product.

FIG. 1b shows a block diagram illustrating a behaviour analysis system 107 in accordance with some embodiments of the present disclosure.

The behaviour analysis system 107 comprises an I/O interface 109, a memory 111 and a processor 113. The I/O interface 109 is configured to receive data from the one or more sensors 103. The data is associated with behaviour parameters corresponding to behaviour of the one or more users for each of the one or more product. The received data is stored in the memory 111. The memory 111 is communicatively coupled to the processor 113. The processor 113 determines behaviour value for each behaviour parameter at each predefined time interval. The processor 113 compares the behaviour values obtained at each predefine time interval to identify the highest behaviour value and a lowest behaviour value. The highest and the lowest behaviour value are obtained for each behaviour parameter corresponding to each of the one or more products 101. The processor 113 provides one or more recommendations to each product based on the highest behaviour value and the lowest behaviour value to improve the performance of the product.

FIG. 1c shows a detailed block diagram illustrating a behaviour analysis system 107 in accordance with some embodiments of the present disclosure.

In one implementation, the behaviour analysis system 107 receives data from one or more sensors 103. As an example, the data is stored within the memory 111. In an embodiment, the data includes behaviour data 115. The behaviour analysis system 107 also includes recommendation data 117 and other data 119. In the illustrated FIG. 1c, one or more modules stored in the memory 111 are described herein in detail.

In one embodiment, the data may be stored in the memory 111 in the form of various data structures. Additionally, the aforementioned data can be organized using data models, such as relational or hierarchical data models. The other data 119 may store data, including temporary data and temporary files, generated by modules for performing the various functions of the behaviour analysis system 107.

In an embodiment, the behaviour data 115 is received from the one or more sensors 103. The behaviour data 115 corresponds to behaviour parameters of one or more users interacting with the one or more products. Each of the one or more sensors 103 monitors behaviour parameter of each user in real-time while interacting with the product and provides data associated with the corresponding behaviour parameter to the behaviour analysis system 107. Therefore, the behaviour analysis system 107 receives data from the one or more sensors 103. The data corresponds to behaviour parameter associated with behaviour of users for each product. The behaviour analysis system 107 determines behaviour value for each behaviour parameter.

In an embodiment, the recommendation data 117 includes information of one or more recommendations to be provided for each product. As an example, if the behaviour value for the behaviour parameter “expression” is less, the recommendation provided by the behaviour analysis system 107 may be to modify the look and feel of the interface of the product.

In an embodiment, the data stored in the memory 111 are processed by the modules of the behaviour analysis system 107. The modules may be stored within the memory 111 as shown in FIG. 1c. In an example, the modules, communicatively coupled to the processor 113, may also be present outside the memory 111.

In one implementation, the modules may include, for example, a receiving module 121, behaviour value determination module 123, identification module 125, recommendation module 127 and other modules 129. The other modules 129 may be used to perform various miscellaneous functionalities of the behaviour analysis system 107. It will be appreciated that such aforementioned modules may be represented as a single module or a combination of different modules.

In an embodiment, the receiving module 121 is configured to receive data from one or more sensors 103. The one or more sensors 103 are configured at each of one or more products being analyzed. The data is associated with behaviour parameters. The behaviour parameters may include, but not limited to, expression of users, interaction level of users, occupancy level of users and voice level of the users. The behaviour parameter corresponds to behaviour of the users while interacting with each product. The sensors 103 monitor the behaviour parameters in real time and provide the data associated with the behaviour parameters to the behaviour analysis system 107.

In an embodiment, the behaviour value determination module 123 is configured to determine behaviour value for each behaviour parameter. Each product is associated with corresponding behaviour values. As an example, considering three products namely a first product, a second product and a third product configured at a public place. There may be users interacting with each of the first product, second product and third product at different time intervals. As an example four behaviour parameters are monitored namely, expression of the users, interaction of the users, voice level of the users and occupancy level of the users. For each of the four behaviour parameter, the user behaviour is captured by the sensors 103 and the corresponding behaviour values are identified. As an example, the behaviour values are numerical values provided for each behaviour parameter. As an example, the behaviour values corresponding to the first product may be 3 for expression, 4 for voice level, 6 for interaction and 6 for occupancy level. Similarly, the behaviour values corresponding to the second product may be 4 for expression, 5 for voice level, 7 for interaction and 7 for occupancy level. The behaviour values corresponding to the third product may be 5 for expression, 3 for voice level, 8 for interaction and 9 for occupancy level.

In an embodiment, the identification module 125 compares the behaviour values corresponding to each product to identify the highest behaviour value and the lowest behaviour value for each behaviour parameter. The highest behaviour value for the behaviour parameter “expression of the users” is 5 which correspond to the third product. The lowest behaviour value for the behaviour parameter “expression of the users” is 3 which correspond to the first product. The highest behaviour value for the behaviour parameter “voice level of the users” is 5 which corresponds to the second product and the. The lowest behaviour value for the behaviour parameter “voice level of the users” is 3 which correspond to the third product. The highest behaviour value for the behaviour parameter “interaction of the users” is 8 which correspond to the third product. The lowest behaviour value for the behaviour parameter “interaction of the users” is 6 which correspond to the first product. The highest behaviour value for the behaviour parameter “occupancy level of the users” is 9 which correspond to the third product. The lowest behaviour value for the behaviour parameter “occupancy level of the users” is 6 which correspond to the first product.

In an embodiment, the recommendation module 127 is configured to provide one or more recommendations for improving the performance of the product. As seen in the abovementioned example, the highest behaviour value for the behaviour parameter “expression of the users” is 5. Therefore, the one or more recommendations provided to the first and the second product may be to improve the user interface which is similar to the third product for improving the performance of the first and the second product in terms of “expression of the users”. Similarly, the highest behaviour value for the behaviour parameter “voice level of the users” is 5. Therefore, the one or more recommendations provided to the first and the third product may be to implement one or more events in the first and the third product which has more excitement level and thereby increase the voice level of the users while interacting with the products. The one or more recommendations are provided in order to improve the performance of the first and the second product in terms of “voice level of the users”. The highest behaviour value for the behaviour parameter “interaction of the users” is 8. The interaction of the users at the third product is more. Therefore, the one or more recommendations provided to the first and the second product is to customize the events or modify the interface to make it user friendly in the products so that the performance of the first and the second product may be improved in terms of interaction of the users”. The highest behaviour value for the behaviour parameter “occupancy level of the users” is 9 which indicate that there is more number of users interacting with the third product. Therefore, the one or more recommendations provided may be to provide the event or the user interface similar to that of the third product to the first and the second product for improving the performance in terms of the “occupancy level of the users”.

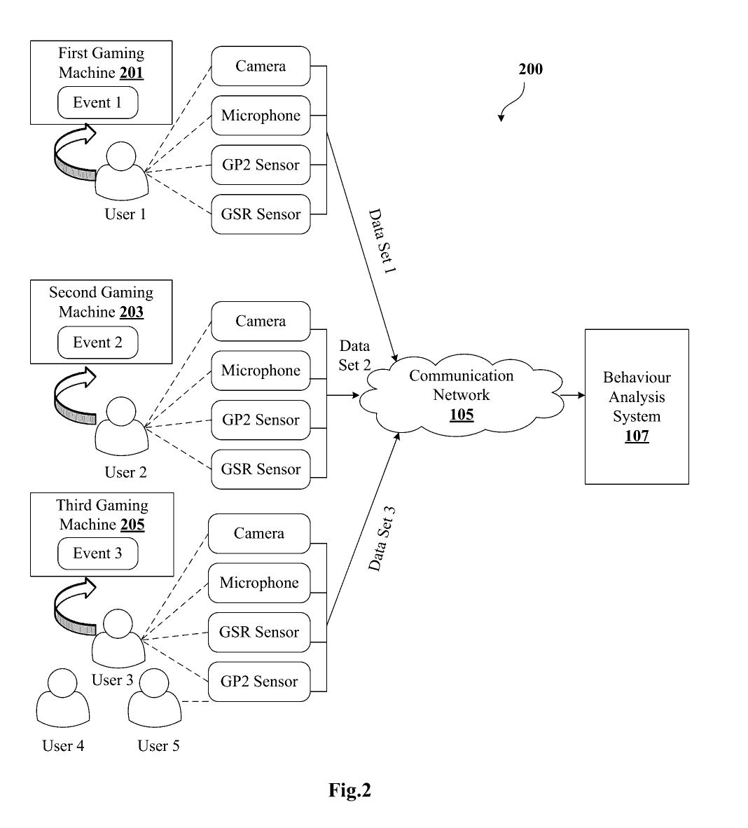

FIG. 2 shows a block diagram 200 illustrating a method for improving performance of one or more products in accordance with some exemplary embodiments of the present disclosure.

As shown in FIG. 2, three gaming machines namely a first gaming machine 201, a second gaming machine 203 and a third gaming machine 205 are configured. The one or more sensors like camera, microphone, GP2 sensor and GSR sensor are configured at each gaming machine. As an example the first gaming machine 201 is configured with event 1, the second gaming machine 203 with event 2 and the third gaming machine 201 is configured with event 3. As an example, consider that the events occurring in the products are games. The user 1 is interacting with the first gaming machine 201. The user 2 is interacting with the second gaming machine 203 and the user 3 is interacting with the third gaming machine 205. The sensors configured near/in the vicinity of the first gaming machine 201 capture user 1 behaviour while playing game 1 and provide data associated with each behaviour parameter to the behaviour analysis system 107. For example, the sensor may be a camera captures expression of the user 1 while playing game 1 in the first gaming machine 201. The microphone captures voice level of the user 1 while playing the game 1. The GSR sensor captures the response of the user 1 while playing the game 1 and the GP2 sensor captures the occupancy level of the user 1 at the first gaming machine 201. The occupancy level indicates the number of users around the first gaming machine 201. The data set 1 corresponds to the first gaming machine 201 i.e data of behaviour parameters of user 1 while playing the game 1 in first gaming machine 201. Similarly each of the one or more sensors configured at second gaming machine 203 captures behaviour of user 2 while playing game 2 in the second gaming machine 203 and transmits data set 2 to the behaviour analysis system 107. The one or more sensors configured at the third gaming machine 205 transmit data set 3 to the behaviour analysis system 107. The one or more sensors configured at each gaming machine continuously transmit data set to the behaviour analysis system 107. The receiving module 121 in the behaviour analysis system 107 receives the data sets and stores the data sets in the memory 111. The behaviour value determination module 123 determines behaviour value for each behaviour parameters in the data set. The behaviour values are identified for each predefined time interval. As an example, the predefined time interval may be 10-11 am of the day. Therefore, the data sets received in the time interval 10-11 am is considered for determining the behaviour values.

As an example, the data set 1 corresponds to behaviour parameter associated with user 1 for game 1 in the first gaming machine 201. The behaviour value for the behaviour parameter “expression” is 5, the behaviour value for the behaviour parameter “voice level” is 6, the behaviour value for the behaviour parameter “interaction” is 7 and the behaviour value for the behaviour parameter “occupancy” is 4. Similarly, the data set 2 corresponds to behaviour parameter associated with user 2 for game 2 in the second gaming machine 203. The behaviour value determined for the behaviour parameter “expression” is 6, the behaviour value determined for the behaviour parameter “voice level” is 5, the behaviour value determined for the behaviour parameter “interaction” is 4 and the behaviour value determined for the behaviour parameter “occupancy” is 5. In a similar manner, the data set 3 corresponds to behaviour parameter associated with user 3 for game 3 in the third gaming machine 205. The behaviour value determined for the behaviour parameter “expression” is 8, the behaviour value determined for the behaviour parameter “voice level” is 9, the behaviour parameter determined for the behaviour parameter “interaction” is 9 and the behaviour value determined for the behaviour parameter “occupancy” is 9. The behaviour value for the behaviour parameter “occupancy” is more since there are more number of users, user 4 and user 5 near the third gaming machine 205. The identification module 125 compares the behaviour values corresponding to each behaviour parameter and for each behaviour parameter the identification module 125 identifies the highest behaviour value and the lowest behaviour value.

The identification module 125 identifies that the highest behaviour value for the behaviour parameter “expression” is 8 which corresponds to the first gaming machine 201 and the lowest behaviour value is which corresponds to the first gaming machine 201. Similarly the highest behaviour value for the behaviour parameter “voice level” is 9 which correspond to the third gaming machine 205 and the lowest behaviour value is 5 which correspond to the second gaming machine 203. The highest behaviour value for the behaviour parameter “interaction” is 8 which correspond to the third gaming machine 205 and the lowest behaviour value is 4 which correspond to the second gaming machine 203. The highest behaviour value for the behaviour parameter “occupancy” is 9 which correspond to the third gaming machine 205 and the lowest behaviour value is 4 which correspond to the first gaming machine 201.

In an embodiment, the behaviour analysis system 107 provides one or more recommendations for improving the performance of the gaming machines based on the determined behaviour values. The behaviour analysis system 107 determines that in the time interval 10-11 am the third gaming machine 205 is the most loudly enjoyed gaming machine, most expressly enjoyed gaming machine and most occupied gaming machine since the behaviour values determined for each of the behaviour parameter corresponding to the third gaming machine 205 is high when compared with the first and the second gaming machine. In an embodiment, the behaviour analysis system 107 may also identify the more profitable gaming machine and least profitable gaming machine based on the behaviour values. Therefore, the recommendation module 127 provides one or more recommendations to the first and the second gaming machine for improving the performance. As an example, the recommendation provided may be to replace event 1 and event 2 with event 3 at time interval 10-11 every day since at the time interval 10-11, the response for the event 3 is good from the users. In an embodiment, if the behaviour value for the behaviour parameter “interaction” is high then the behaviour analysis system 107 determines that the gaming machine is being enjoyed by the individual user more. If the behaviour value for the behaviour parameter “occupancy” is high then the behaviour analysis system 107 determines that the gaming machine is being enjoyed by many users.

In an embodiment, at time interval 4-5 pm, the event 1 may receive good response from the users and there may be more number of users for event 1 since it's a weekend. Therefore, the recommendation provided by the behaviour analysis system 107 in this scenario may be to retain the event only for the weekends and change the event to event 3 during rest of the days.

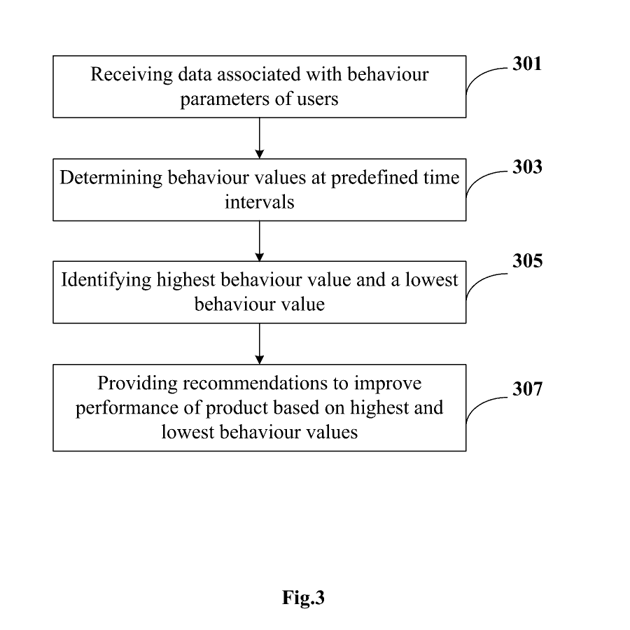

FIG. 3 illustrates a flowchart showing method for improving performance of one or more products in accordance with some embodiments of the present disclosure.

As illustrated in FIG. 3, the method 300 comprises one or more blocks for improving performance of one or more products using a behaviour analysis system 107. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 301, data of one or more behaviour parameters are received. In an embodiment, the receiving module 121 of the behaviour analysis system 107 receives data associated one or more behaviour parameters in real-time. The behaviour parameters are associated with behaviour of one or more users near the product while interacting with the product.

At block 303, behaviour values correspond to each behaviour parameter is determined. In an embodiment, the behaviour value determination module 123 determines behaviour value corresponding to each behaviour parameter. In an embodiment, the behaviour values are numerical values assigned for each behaviour parameter based on the data received from the corresponding sensor.

At block 305, the behaviour values are compared. In an embodiment, the identification module 125 is configured to compare the behaviour values and identify the highest and the lowest behaviour value amongst them. Each product is associated with corresponding behaviour values. The behaviour values correspond to behaviour parameter which is associated with behaviour of users while interacting with the product. As an example, if there are three products then the behaviour values correspond to each of the three products. The behaviour values of each of the three products are compared to identify the highest and the lowest behaviour value.

At block 307, the one or more recommendations are provided. In an embodiment, the recommendation module 127 is configured to provide one or more recommendations for improving performance of the product based on the highest behaviour value and the lowest behaviour value. As an example, if the behaviour value corresponding to the behaviour parameter “voice level” is low then the recommendation provided may be to customize the event to make it more user friendly. As another example, the recommendation provided may be to replace the product itself.

### Computer System

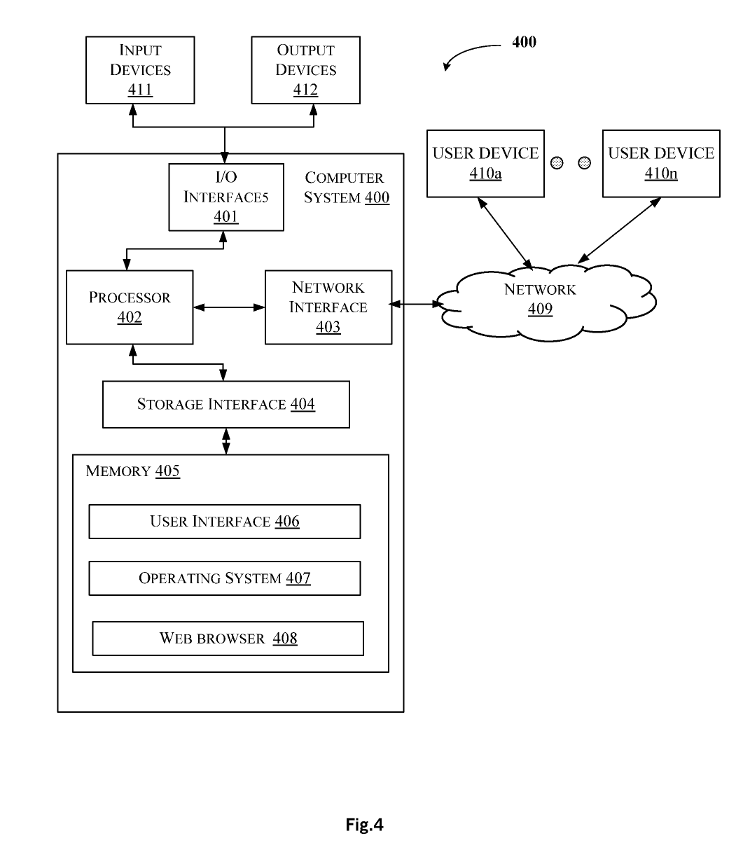

FIG. 4 illustrates a block diagram of an exemplary computer system 400 for implementing embodiments consistent with the present technology. In an embodiment, the computer system 400 is used to improve performance of products based on user behaviour with the products using a behaviour analysis system 107. The computer system 400 may comprise a central processing unit (“CPU” or “processor”) 402. The processor 402 may comprise at least one data processor for executing program components for executing user- or system-generated business processes. A user may include a person, a person using a device such as such as those included in this technology, or such a device itself. The processor 402 may include specialized processing units such as integrated system (bus) controllers, memory management control units, floating point units, graphics processing units, digital signal processing units, etc.

The processor 402 may be disposed in communication with one or more input/output (I/O) devices (411 and 412) via I/O interface 401. The I/O interface 401 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE), WiMax, or the like), etc.

Using the I/O interface 401, the computer system 400 may communicate with one or more I/O devices (411 and 412).

In some embodiments, the processor 402 may be disposed in communication with a communication network 409 via a network interface 403. The network interface 403 may communicate with the communication network 409. The network interface 403 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface 403 and the communication network 409, the computer system 400 may communicate with one or more user devices 410 (a, . . . , n). The communication network 409 can be implemented as one of the different types of networks, such as intranet or Local Area Network (LAN) and such within the organization. The communication network 409 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 409 may include a variety of network devices, including routers, bridges, servers, computing devices, storage devices, etc. The one or more user devices 410 (a, . . . , n) may include, without limitation, personal computer(s), mobile devices such as cellular telephones, smartphones, tablet computers, eBook readers, laptop computers, notebooks, gaming consoles, or the like.

In some embodiments, the processor 402 may be disposed in communication with a memory 405 (e.g., RAM, ROM, etc. not shown in FIG. 4) via a storage interface 404. The storage interface 404 may connect to memory 405 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user interface application 406, an operating system 407, web server 408 etc. In some embodiments, computer system 400 may store user/application data 406, such as the data, variables, records, etc. as described herein. Such databases may be implemented as fault-tolerant, relational, scalable, secure databases such as Oracle or Sybase.

The operating system 407 may facilitate resource management and operation of the computer system 400. Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), International Business Machines (IBM) OS/2, Microsoft Windows (XP, Vista/7/8, etc.), Apple iOS, Google Android, Blackberry Operating System (OS), or the like. User interface 406 may facilitate display, execution, interaction, manipulation, or operation of program components through textual or graphical facilities. For example, user interfaces may provide computer interaction interface elements on a display system operatively connected to the computer system 400, such as cursors, icons, check boxes, menus, scrollers, windows, widgets, etc. Graphical User Interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 400 may implement a web browser 408 stored program component. The web browser may be a hypertext viewing application, such as Microsoft Internet Explorer, Google Chrome, Mozilla Firefox, Apple Safari, etc. Secure web browsing may be provided using Secure Hypertext Transport Protocol (HTTPS) secure sockets layer (SSL), Transport Layer Security (TLS), etc. Web browsers may utilize facilities such as AJAX, DHTML, Adobe Flash, JavaScript, Java, Application Programming Interfaces (APIs), etc. In some embodiments, the computer system 400 may implement a mail server stored program component. The mail server may be an Internet mail server such as Microsoft Exchange, or the like. The mail server may utilize facilities such as Active Server Pages (ASP), ActiveX, American National Standards Institute (ANSI) C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 400 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present technology. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Advantages of the embodiment of the present disclosure are illustrated herein.

In an embodiment, the present disclosure provides a method to analyze behaviour of users while interacting with one or more products for improving the performance of the products.

In an embodiment, the present disclosure provides a method to improve the performance of products which are already being deployed without changing the internal architecture for design of the product.

In an embodiment, the present disclosure provides a method to determine working condition of the product in real-time based on interaction of the user with the product.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the technology.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the technology need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present technology are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for improving product performance, the method comprising:
receiving, by a behavior analysis computing device, data associated with one or more behavior parameters from one or more sensors in real-time, wherein the one or more behavior parameters are associated with behavior of one or more users while interacting with one or more products;
determining, by the behavior analysis computing device, one or more behavior values corresponding to the one or more behavior parameters at predefined time intervals based on the received data;
comparing, by the behavior analysis computing device, the one or more behavior values obtained at each predefined time interval;
identifying, by the behavior analysis computing device, a highest behavior value and a lowest behavior value corresponding to each of the one or more behavior parameters based on the comparison; and
generating and outputting, by the behavior analysis computing device, one or more recommendations for improving the performance of each of the one or more products based on the highest and lowest behavior value corresponding to each of the one or more behavior parameters.

2. The method as claimed in claim 1, wherein the one or more sensors are associated to each of the one or more products.

3. The method as claimed in claim 1, wherein the one or more behavior parameters comprise an expression of the one or more users while interacting with the one or more of the products, an interaction of the one or more users with one or more of the products, a voice level of the one or more users while interacting with the one or more products, or an occupancy level of the one or more users at each of the one or more products.

4. The method as claimed in claim 1, wherein the one or more recommendations are related to one or more of the products.

5. A behavior analysis computing device, comprising:
a processor; and
a memory coupled to the processor, wherein
the memory stores executable instructions, which when executed by the processor, cause the processor to:
receive data associated with one or more behavior parameters from one or more sensors in real-time, wherein the one or more behavior parameters are associated with behavior of one or more users while interacting with each of one or more products;
determine one or more behavior values corresponding to the one or more behavior parameters at predefined time intervals based on the received data;
compare the one or more behavior values obtained at each predefined time interval;
identify a highest behavior value and a lowest behavior value corresponding to each of the one or more behavior parameters based on the comparison; and
generate and output one or more recommendations for improving the performance of each of the one or more products based on the highest and lowest behavior value corresponding to each of the one or more behavior parameters.

6. The behavior analysis computing device as claimed in claim 5, wherein the one or more sensors are associated to each of the one or more products.

7. The behavior analysis computing device as claimed in claim 5, wherein the one or more behavior parameters comprise an expression of the one or more users while interacting with the one or more of the products, an interaction of the one or more users with one or more of the products, a voice level of the one or more users while interacting with the one or more products, or an occupancy level of the one or more users at each of the one or more products.

8. The behavior analysis computing device as claimed in claim 5, wherein the one or more recommendations are related to one or more of the products.

9. A non-transitory computer readable medium comprising instructions stored thereon for improving product performance, which when executed by at least one processor, cause the processor to perform operations comprising:
receiving data associated with one or more behavior parameters from one or more sensors in real-time, wherein the one or more behavior parameters are associated with behavior of one or more users while interacting with each of one or more products;
determining one or more behavior values corresponding to the one or more behavior parameters at predefined time intervals based on the received data;
comparing the one or more behavior values obtained at each predefined time interval;
identifying a highest behavior value and a lowest behavior value corresponding to each of the one or more behavior parameters based on the comparison; and
generate and output one or more recommendations for improving the performance of each of the one or more products based on the highest and lowest behavior value corresponding to each of the one or more behavior parameters.

10. The non-transitory computer readable medium as claimed in claim 9, wherein the one or more sensors are associated to each of the one or more products.

11. The non-transitory computer readable medium as claimed in claim 9, wherein the one or more behavior parameters comprise an expression of the one or more users while interacting with the one or more of the products, an interaction of the one or more users with one or more of the products, a voice level of the one or more users while interacting with the one or more products, or an occupancy level of the one or more users at each of the one or more products.

12. The non-transitory computer readable medium as claimed in claim 9, wherein the one or more recommendations are related to one or more of the products.
